(19) United States
(12) Patent Application Publication
(10) Pub. No.: US 2020/0328606 A1
(43) Pub. Date: Oct. 15, 2020

(54) Wireless Charging Device with Detachable Base

(71) Applicants: Defond Electech Co., Ltd., Dongguan (CN); Defond Components Limited, Chaiwan (HK)

(72) Inventors: Cheng Chen Nieh, Dongguan (CN); Wai Cheong Wilson Chu, Dongguan (CN); Sen Xian Fang, Dongguan (CN)

(73) Assignees: Defond Electech Co., Ltd.; Defond Components Limited

(21) Appl. No.: 16/820,110

(22) Filed: Mar. 16, 2020

(30) Foreign Application Priority Data
Apr. 9, 2019 (CN) 201920482652.1

(51) Int. Cl. H02J 7/00; H02J 7/02; H02J 50/12

(52) U.S. Cl. CPC H02J 7/0045; H02J 50/12; H02J 7/02

(57) ABSTRACT

A wireless charging device with a detachable base, which comprises a base and a power supply device detachably connected to the base. The base is provided with a wireless charging module, and the power supply device is internally provided with a power supply and is further provided with a first electrical connection part electrically connected to the power supply. The base is provided with a second electrical connection part which is matched with the first electrical connection part and electrically connected to the wireless charging module. When the base is connected to the power supply device, the first electrical connection part is conductive with the second electrical connection part. The wireless charging device with a detachable can be used to wirelessly charge electronic devices needing different charging powers by means of power supply devices of different specifications.

### FIELD OF INVENTION

The present invention relates to the technical field of wireless charging, in particular to a wireless charging device with a detachable base.

### BACKGROUND OF INVENTION

### Description of Related Art

Deriving from wireless power transmission technology, wireless charging technology includes low-power wireless charging and high-power wireless charging. Low-power wireless charging is realized generally in an electromagnetic induction manner, such as the Qi manner for charging mobile phones. However, wireless charging of electric vehicles of ZTE is realized in an induction manner. High-power wireless charging is realized generally in a resonance manner, that is, power supply equipment transmits energy to electrical devices, and the electrical devices receive the energy to charge batteries and to operate.

At present, wireless charging in the electromagnetic induction manner is widely adopted, and many portable wireless charging devices have come into being. However, most wireless charging devices on the present market can only provide constant output power, which is not suitable for some electronic devices with special requirements.

### SUMMARY OF THE INVENTION

The objective of the utility model is to overcome the shortcomings and defects of the prior art by providing a wireless charging device with a detachable base, which can be used to wirelessly charge electronic devices with different charging power requirements by means of power supply devices of different specifications.

The utility model is fulfilled through the following technical solution:

A wireless charging device with a detachable base comprises a base and a power supply device detachably connected to the base, wherein the base is provided with a wireless charging module, and the power supply device is internally provided with a power supply and is further provided with a first electrical connection part electrically connected to the power supply; the base is provided with a second electrical connection part which is matched with the first electrical connection part and electrically connected to the wireless charging module; when the base is connected to the power supply device, the first electrical connection part is conductive with the second electrical connection part; and the base is further provided with a USB interface electrically connected to the second electrical connection part.

Wherein, the wireless charging module is a charging coil.

Wherein, the second electrical connection part includes a plurality of terminals electrically connected to the wireless charging module, and the first electrical connection part includes a plurality of contacts electrically connected to the power supply.

Wherein, the second electrical connection part includes a plurality of contacts electrically connected to the wireless charging module, and the first electrical connection part includes a plurality of terminals electrically connected to the power supply.

Wherein, the first electrical connection part is arranged on the top face of the power supply device, and the second electrical connection part is arranged on the bottom face of the power supply device.

Wherein, the base is provided with a slider, and the power supply device is provided with a locating slide groove matched with the slider.

The utility model has the following beneficial effects:

1. The charging requirements of electronic devices needing different charging powers are met: according to the wireless charging device with a detachable base of the utility model, the base is conductive with the power supply device by means of contact of the first electrical connection part and the second electrical connection part, so that the power supply is conductive with the wireless charging module on the base to supply power to the wireless charging module; and when electronic devices of different specifications need to be charged, the power supply device is detached from the base and is then replaced with a power supply device of a different specification, and the new power supply device is assembled on the base to fulfill wireless charging.

2. Wired charging can be realized during wireless charging: during wireless charging, the wireless charging device with a detachable base of the utility model can be externally connected to a data line via the USB interface 3 to realize wired charging with the same power as wireless charging, so that the requirements of more electronic devices are met.

### BRIEF DESCRIPTION OF THE DRAWINGS

FIG. 1 is a perspective structural view of Embodiment 1 of the utility model;

FIG. 2 is an exploded structural view of Embodiment 1 of the utility model;

FIG. 3 is a structural view of the bottom end of a base in Embodiment 1 of the utility model.

### DESCRIPTION OF THE PREFERRED EMBODIMENTS

The implementations of the utility model are explained below with specific embodiments. Those skilled in the art can easily appreciate other advantages and effects of the utility model on the basis of the contents in the specification, and can also implement or apply the utility model in other embodiments and make various transformations or changes on the details in the specification on the basis of different viewpoints and applications without deviating from the spirit of the utility model.

It should be noted that the structures shown in the accompanying drawings of the specification are only used for assisting those familiar with the technology in understanding and reading in cooperation with the contents disclosed in the specification, and are not intended to limit the implementing conditions of the utility model, thus having no substantive meaning technically. Any structural modifications or transformations achieved without affecting the efficacy and purpose achieved by the utility model should still fall within the scope of the technical contents disclosed by the utility model.

### Embodiment 1

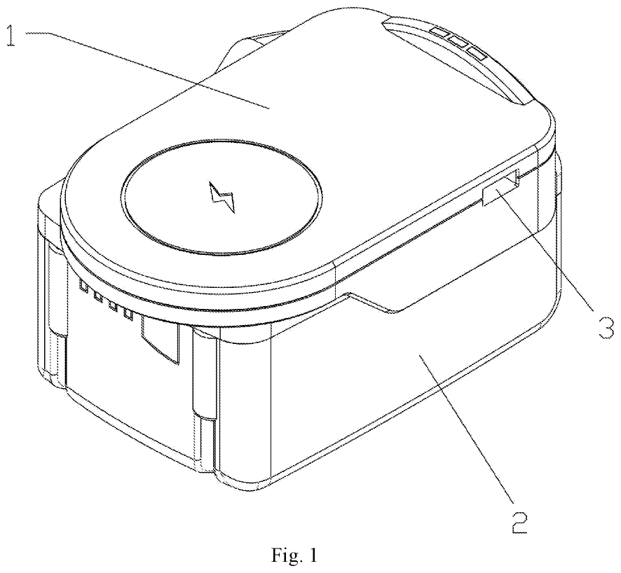

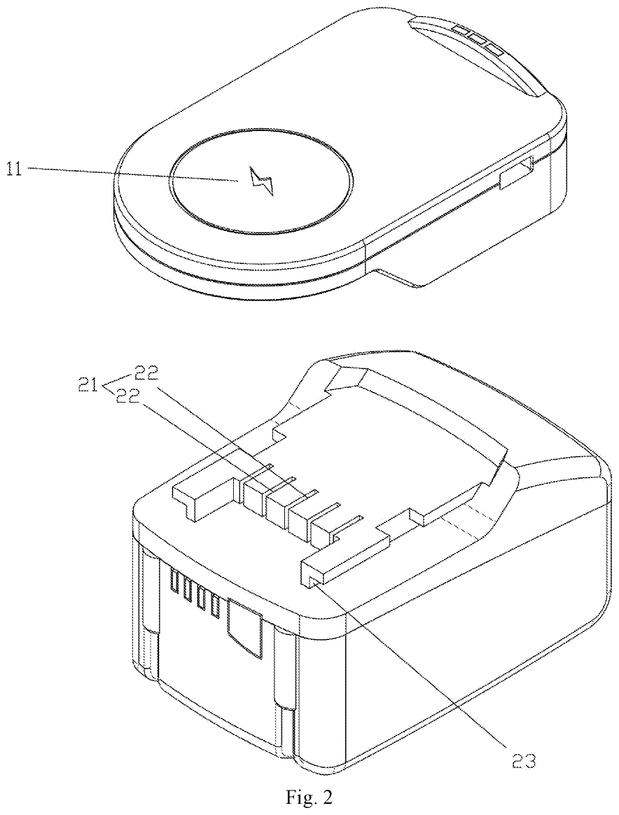

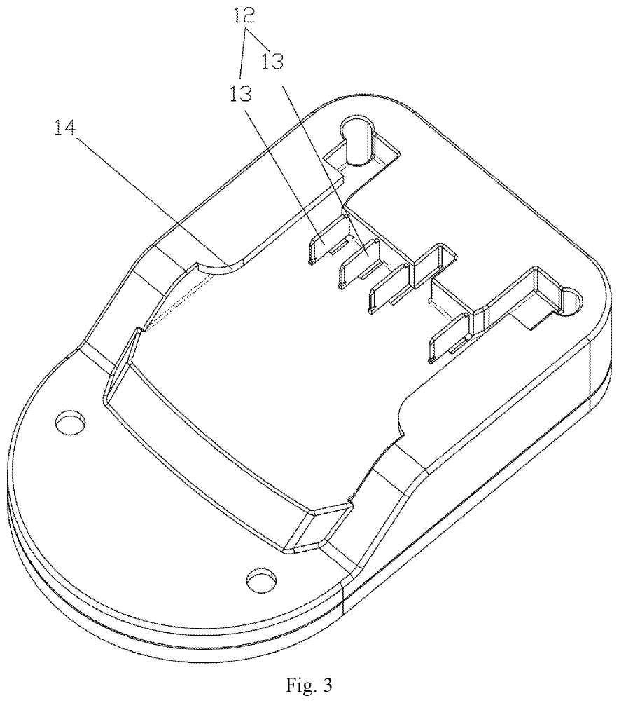

As shown in FIG. 1 to FIG. 3, a wireless charging device with a detachable base comprises a base 1 and a power supply device 2 detachably connected to the base 1, wherein the base 1 is provided with a wireless charging module 11, and the power supply device 2 is internally provided with a power supply and is further provided with a first electrical connection part 21 electrically connected to the power supply; the base 1 is provided with a second electrical connection part 12 which is matched with the first electrical connection part 1 and electrically connected to the wireless charging module 11; when the base 1 is connected to the power supply device 2, the first electrical connection part 21 is conductive with the second electrical connection part 12; and the base 1 is further provided with a USB interface 3 electrically connected to the second electrical connection part 12. Wherein, the wireless charging module 11 is a charging coil.

In this embodiment, the power supply device 2 is of different types, and different types of power supply devices 2 have different output powers and can be changed according to different needs.

The wireless charging device with a detachable base in this embodiment has the following effects:

1. The charging requirements of electronic devices needing different charging powers are met: according to the wireless charging device with the detachable base 1 in this embodiment, the base 1 is conductive with the power supply device 2 by means of contact of the first electrical connection part 21 and the second electrical connection part 12, so that the power supply is conductive with the wireless charging module 11 on the base 1 to supply power to the wireless charging module 11; and when the electronic devices of different specifications need to be charged, the power supply device 2 is detached from the base 1 and is then replaced with a power supply device 2 of a different specification, and the new power supply device 2 is assembled on the base 1 to fulfill wireless charging.

2. Wired charging can be realized during wireless charging: during wireless charging, the wireless charging device with the detachable base 1 in this embodiment can be externally connected to a data line via the USB interface 3 to realize wired charging with the same power as wireless charging, so that the requirements of more electronic devices are met.

Particularly, the first electrical connection part 21 includes a plurality of terminals 13 electrically connected to the wireless charging module 11, and the second electrical connection part 12 includes a plurality of contacts 22 electrically connected to the power supply. When the base 1 and the power supply device 2 are assembled, the terminals 13 make contact with the contacts 22, so that the wireless charging module 11 is conductive with the power supply.

Particularly, the first electrical connection part 21 is arranged on the top face of the power supply device 2, and the second electrical connection part 12 is arranged on the bottom face of the power supply device 2, so that the base 1 in this embodiment can be disposed on the power supply device 2; and the bottom end of the base 1 is matched with the bottom end of the power supply device 2 to fulfill conduction.

Particularly, the base 1 is provided with a slider 14, and the power supply device 2 is provided with a locating slide groove 23 matched with the slider 14, so that location and match of the base 1 and the power supply device 2 are facilitated.

### Embodiment 2

In this embodiment, the second electrical connection part 12 includes a plurality of contacts electrically connected to the wireless charging module 11, and the first electrical connection part 21 includes a plurality of terminals 13 electrically connected to the power supply. When the base 1 and the power supply device 2 are assembled, the terminals make contact with the contacts, so that the wireless charging module 11 is conductive with the power supply.

It should be noted that, except for the above technical features different from those of Embodiment 1, other technical features of this embodiment are the same as those of Embodiment 1 and will no longer be repeated herein.

Finally, it should be noted that the above embodiments are only used to explain the technical solutions of the utility model, and are not intended to limit the protection scope of the utility model. Although the utility model has been expounded with reference to the preferred embodiments, those ordinarily skilled in the art should understand that modifications or equivalent replacements can be made on the technical solutions of the utility model without deviating from the essence and scope of the technical solutions of the utility model.

What is claimed is:

1. A wireless charging device with a detachable base, comprising a base provided with a wireless charging module and a power supply device detachably connected to the base, wherein the power supply device is internally provided with a power supply and is further provided with a first electrical connection part electrically connected to the power supply; the base is provided with a second electrical connection part which is matched with the first electrical connection part and electrically connected to the wireless charging module; when the base is connected to the power supply device, the first electrical connection part is conductive with the second electrical connection part; and the base is further provided with a USB interface electrically connected to the second electrical connection part.

2. The wireless charging device with a detachable base according to claim 1, wherein the wireless charging module is a charging coil.

3. The wireless charging device with a detachable base according to claim 1, wherein the second electrical connection part includes a plurality of terminals electrically connected to the wireless charging module, and the first electrical connection part includes a plurality of contacts electrically connected to the power supply.

4. The wireless charging device with a detachable base according to claim 1, wherein the second electrical connection part includes a plurality of contacts electrically connected to the wireless charging module, and the first electrical connection part includes a plurality of terminals electrically connected to the power supply.

5. The wireless charging device with a detachable base according to claim 1, wherein the first electrical connection part is arranged on a top face of the power supply device, and the second electrical connection part is arranged on a bottom face of the power supply device.

6. The base-detachable wireless charging device according to claim 1, wherein the base is provided with a slider, and the power supply device is provided with a locating slide groove matched with the slider.
